(19) United States
(12) Patent Application Publication
(10) Pub. No.: US 2018/0362725 A1
(43) Pub. Date: Dec. 20, 2018

(54) MANUFACTURING METHOD FOR ELASTIC COMPOSITE MATERIAL

(71) Applicant: TAIWAN CARBON NANO TECHNOLOGY CORPORATION, MIAOLI COUNTY (TW)

(72) Inventors: Chao-Chieh Lin, MIAOLI COUNTY (TW); Chia-Hung Li, MIAOLI COUNTY (TW); Ching-Tung Hsu, MIAOLI COUNTY (TW); Chun-Hsien Tsai, MIAOLI COUNTY (TW); Ting-Chuan Lee, MIAOLI COUNTY (TW); Chun-Jung Tsai, MIAOLI COUNTY (TW)

(21) Appl. No.: 16/006,029

(22) Filed: Jun. 12, 2018

(30) Foreign Application Priority Data
Jun. 14, 2017 (TW) 106119785

(51) Int. Cl. C08K 3/04; C08K 5/548; C08L 83/04; C08J 5/04

(52) U.S. Cl. CPC C08K 3/042; C08K 3/041; C08K 5/548; C08L 2312/00; C08J 5/042; C08J 5/043; C08L 2207/04; C08L 83/04

(57) ABSTRACT

The invention provides a manufacturing method for an elastic composite material, which comprises the following steps of: mixing a carbon material with a silicon rubber material, and uniformly dispersing the carbon material in the silicon rubber material to form a mixed compound; mixing the mixed compound with a (Bis(triethoxysilylpropyl)tetrasulfide) and a cross-linking agent to form a mixture; and heating the mixture to harden it to obtain the elastic composite material. The elastic composite material produced by the above method has improved durability.

### FIELD OF THE INVENTION

The present invention relates to a manufacturing method for an elastic composite material and more particularly to a manufacturing method for an elastic composite material capable of producing products having improved tensile stress and durability.

### BACKGROUND OF THE INVENTION

Elastic materials are widely used and demanded in various industries and people's livelihoods, from daily necessities of automotive tires, shoes, tapes, sporting goods, floorings and conveyor belts to precision industries such as electronics, semiconductor industry, and space parts, etc. The types are all-inclusive, such as nitrile rubber, silicone rubber, fluoro carbon rubber, styrene butadiene rubber, etc.

Among them, take rubber as an example, its composition and formula have undergone many evolutions, improvements, and developments to have a variety of current types and patterns: the initial collection of natural rubber from rubber trees, and the use of rubber vulcanization methods to improve the properties of natural rubber, and later various synthetic rubbers are manufactured by artificial ways according to the demands and requirements by using coal, petroleum, and natural gas as the main raw materials. Among them, because of different formula compositions, these rubber products are given unique physical properties.

For examples, the rubber composition disclosed in the U.S. Pat. No. 9,228,077B2 comprises a rubber component (A), a farnesene polymer (B), and silica (C), and the content of the polymer in the rubber composition is 1 to 100 parts by weight. A tire made by using the rubber composition of the patent has excellent rolling impedance properties and can suppress a decrease in mechanical strength and hardness; or, the vulcanizable rubber mixture disclosed in the U.S. Pat. No. 9,593,228B2 comprises: (A) at least one diene rubber functionalized with carboxyl groups and/or hydroxyl groups and/or salts thereof; (B) at least one pale-coloured filler; (C) trimethylolpropane; and (D) at least one fatty acid. Wherein the sum of the amounts of the ingredients (C) and (D) is 0.1 to 20 parts by weight based on the ingredient (A) of 100 parts by weight as the criterion. The vulcanizable rubber mixture can be applied to a tire tread pattern of vehicles, and has the advantages of high wear resistance performance and low rolling impedance.

However, the pursuit of quality is often endless. Especially most elastic materials are often faced with wear problems during use, and are prone to aging problems as the use time increases. All of the above are still issues that current research teams are eager to improve and breakthrough.

### SUMMARY OF THE INVENTION

A main object of the present invention is to solve the drawback of the conventional silicon rubber, which is not ideally durable.

In order to achieve the above object, the present invention provides a formula for manufacturing an elastic composite material, and a manufacturing method for an elastic composite material. Products made according to the formula have the advantage of better durability, thereby improving the life of the products.

Accordingly, the present invention provides a formula for manufacturing an elastic composite material, comprising: a silicon rubber material; a carbon material accounted for a weight percentage of between 0.0005% and 10% of the total composition, and the carbon material is selected from a group consisting of single-walled carbon nanotubes, multi-walled carbon nanotubes, graphene, graphene oxide and combinations thereof; a (Bis(triethoxysilylpropyl)tetrasulfide) accounted for a weight percentage of between 0.0005% and 15% of the total composition; and a cross-linking agent accounted for a weight percentage of between 0.5% and 2% of the total composition.

The invention also provides a manufacturing method for an elastic composite material, comprising the following steps of:

mixing a carbon material with a silicon rubber material, and uniformly dispersing the carbon material in the silicon rubber material to form a mixed compound, wherein the carbon material is accounted for a weight percentage of between 0.01% and 20% of the mixed compound;

mixing the mixed compound with a (Bis(triethoxysilylpropyl)tetrasulfide) and a cross-linking agent to form a mixture, wherein the cross-linking agent is accounted for a weight percentage of between 0.5% and 2% of the mixture; and

heating the mixture to harden it to obtain the elastic composite material.

The invention also provides a manufacturing method for an elastic composite material, comprising the following steps of:

mixing a carbon material with a rubber processing oil, and uniformly dispersing the carbon material in the rubber processing oil to form a composite, wherein the carbon material is accounted for a weight percentage of between 0.005% and 10% of the composite;

mixing the composite with a (Bis(triethoxysilylpropyl)tetrasulfide) and a cross-linking agent to form a mixture, wherein the cross-linking agent is accounted for a weight percentage of between 0.5% and 2% of the mixture; and

heating the mixture to harden it to obtain the elastic composite material.

The present invention also provides a tire tread rubber comprising the above formula.

The present invention also provides a tire tread rubber that is made by the abovementioned method.

Therefore, products produced with the formula of the present invention have at least the following advantages compared to the conventional silicon rubber products:

1. The products produced with the formula for manufacturing the elastic composite material of the present invention have been tested and have proved not only the durability is improved, but also the tensile strength is enhanced and the hardening time is lengthened, which help to enhance the processability of the elastic composite material.

2. The present invention effectively reduces the loss factor tan δ by adding a specific ratio of the carbon material and the (Bis(triethoxysilylpropyl)tetrasulfide) in the silicon rubber material. Therefore, tires produced with the formula for manufacturing the elastic composite material of the present invention have relative low rolling resistance, may reduce oil consumption, and thereby have an energy-saving effect.

### DETAILED DESCRIPTION OF THE PREFERRED EMBODIMENTS

The detailed description and technical content of the present invention will be described below in conjunction with the embodiments.

A formula for manufacturing an elastic composite material of the present invention mainly comprises a silicon rubber material, a carbon material, a (Bis(triethoxysilylpropyl)tetrasulfide) and a cross-linking agent.

In one embodiment of the present invention, the silicon rubber material may be a natural rubber or a synthetic rubber. However, the present invention has no particular limitations on this. Those having ordinary skill in the art may select a suitable rubber type according to the desired elastic composite material to be made.

The carbon material may be single-walled carbon nanotubes, multi-walled carbon nanotubes, graphene, graphene oxide, or combinations thereof. The carbon material is accounted for a weight percentage of between 0.0005% and 10% of the total composition, preferably between 0.005% and 3%. In another preferred embodiment of the present invention, the carbon material may be treated with a functionalization to obtain a substituent group selected from carboxyl groups, hydroxyl groups, and combinations thereof. The “functionalization” may be complete by, for example, adding the carbon material in a mixed acid at a temperature of about 70° C., after boiling for 30 minutes to 8 hours, the carbon material is filtered and rinsed at a ratio of the carbon material to clear water of 1:100, and the carbon material is filtered again and dried.

In the above “functionalization” step, the mixed acid may be prepared by mixing nitric acid and sulfuric acid in a volume ratio of 1:3, and a ratio of the carbon tubes to the mixed acid may be 1:100. However, it should be understood that the relationships between the above-described “functionalization” method, temperature, time, and ratio are within the scope of those having ordinary skill in the art that can be changed based on conditions. Any methods may be applied to the present invention as long as they can cause the carbon material to have a substituent group selected from carboxyl groups, hydroxyl groups, and combinations thereof, and the present invention is not limited to the abovementioned method.

The addition of the (Bis(triethoxysilylpropyl)tetrasulfide) helps to convert the bonding between the silicon rubber material and the carbon material from a physical bond to a chemical bond, and therefore, basic properties such as tensile strength, etc. may be enhanced. In one embodiment of the present invention, the (Bis(triethoxysilylpropyl)tetrasulfide) is accounted for a weight percentage of between 0.0005% to 15% of the total composition, preferably between 0.005% and 10%, and more preferably between 0.05% and 5%.

Furthermore, cross-linking agents suitable for using in the present invention include, but are not limited to: sulfocompounds (such as sulfur), peroxides, metallic oxides, ester chemical compounds, amine chemical compounds, resin chemical compounds, selenium, and tellurium; as long as the cross-linking agent may react chemically with the rubber molecules at a high temperature of about 150° C. to 195° C. to form a three-dimensional network structure. In one embodiment of the present invention, the cross-linking agent is accounted for a weight percentage of between 0.5% and 2% of the total composition.

In addition to the above-mentioned cross-linking agent, an additive may be further added for the purpose of softening, plasticizing, or lubricating. The additive suitable for using in the present invention may be zinc oxide, stearic acid, or an accelerator of a thiazole type and a sulfonamide type. However, those having ordinary skill in the art may choose according to the demands and requirements. The present invention has no particular limitations on this as long as the additive is accounted for a weight percentage of below 5% of the total composition.

In one embodiment of the present invention, the formula for manufacturing the elastic composite material may further comprise a filler, and the filler is selected from a group consisting of carbon black, white smoke, carbon fiber, glass fiber, and combinations thereof. As for the filler, its weight percentage accounted for the total composition may be between 10% and 65%, preferably between 10% and 50%.

In one embodiment of the present invention, the formula for manufacturing the elastic composite material may further comprise a rubber processing oil accounted for a weight percentage of between 0.00001% and 25% of the total composition. The present invention has no particular limitations on the types of rubber processing oil. For examples, the rubber processing oils such as paraffinic oil, naphthenic oil, or modified aromatic hydrocarbon oil may be used. Those having ordinary skill in the art may select a suitable rubber processing oil according to the demands and requirements.

As for the manufacturing method for the elastic composite material, for example, a carbon material may be mixed with a silicon rubber material, and the carbon material is uniformly dispersed in the silicon rubber material to form a mixed compound, so that the carbon material is accounted for a weight percentage of between 0.01% and 20% of the mixed compound; then, after the mixed compound is mixed with a (Bis(triethoxysilylpropyl)tetrasulfide) and a cross-linking agent accounted for a weight percentage of between 0.5% and 2% of a mixture that is formed by mixing the previous three elements, the mixture is heated to harden it to obtain the elastic composite material. The heating temperature may be a temperature often used for rubber hardening (vulcanization), that is, between 150° C. and 185° C.

Alternatively, in another embodiment of the present invention, the elastic composite material may be manufactured by another method. A carbon material and a rubber processing oil are mixed, and the carbon material is uniformly dispersed in the rubber processing oil to form a composite, so that the carbon material is accounted for a weight percentage of between 0.005% and 10% of the composite. Then, after the composite is mixed with a (Bis(triethoxysilylpropyl)tetrasulfide) and a cross-linking agent accounted for a weight percentage of between 0.5% and 2% of a mixture that is formed by mixing the previous three elements, the mixture is heated to harden it to obtain the elastic composite material. The heating temperature may be a temperature often used for rubber hardening (vulcanization), that is, between 150° C. and 185° C.

In the abovementioned manufacturing method, further comprises adding a filler in the mixture so that the filler is accounted for a weight percentage of between 10% to 65% of the total composition. And as mentioned previously, the filler may be selected from a group consisting of carbon black, white smoke, carbon fiber, glass fiber, and combinations thereof.

In addition, in the abovementioned manufacturing method, further comprises a step of treating the carbon material with a functionalization to obtain a substituent group selected from carboxyl groups, hydroxyl groups, and combinations thereof. Since a surface of the carbon material includes carboxyl groups or hydroxyl groups, after the functionalization, it is easier to react with the (Bis(triethoxyslylpropyl)tetrasulfide) to produce chemical bonds, which may enhance the basic properties such as tensile strength and electrical property of the elastic composite material.

The abovementioned method of “uniformly dispersing the carbon material in the silicon rubber material” and “uniformly dispersing the carbon material in the rubber processing oil” may employ, for examples, a double-roller mixing mill, a kneader, and a banbury for dispersion, as long as the carbon material is able to be reliably dispersed in the silicon rubber material and the rubber processing oil. The present invention has no particular limitations on this.

Then, the elastic composite material of comparative example 1, embodiment 1, embodiment 2, embodiment 3, and embodiment 4 are respectively manufactured according to the different formulas in table 1 below for subsequent physical tests. The tests include tensile stress, M300, and loss factor tan δ. The results are shown in table 2 below.

TABLE 1
Unit (weight percentage)

| | Compar- | | | | |
|---|---|---|---|---|---|
| | ative | Em- | Em- | Em- | Em- |
| | exam- | bodi- | bodi- | bodi- | bodi- |
| | ple 1 | ment 1 | ment 2 | ment 3 | ment 4 |
| Styrene | 35.14% | 34.53% | 34.83% | 33.38% | 34.24% |
| butadiene | | | | | |
| rubber (SBR) | | | | | |
| SBR/modified | 25.77% | 25.32% | 25.54% | 24.48% | 25.11% |
| CNT mixed | | | | | |
| compound | | | | | |
| (contains | | | | | |
| 10% modified | | | | | |
| CNT) | | | | | |
| (Bis(triethoxy- | 0.00% | 0.00% | 0.87% | 0.00% | 2.57% |
| silylpropyl)tet- | | | | | |
| rasulfide) | | | | | |
| (liquid state) | | | | | |
| (Bis(triethoxy- | 0.00% | 1.73% | 0.00% | 5.01% | 0.00% |
| silylpropyl)tet- | | | | | |
| rasulfide) | | | | | |
| (solid state) | | | | | |
| Rubber | 5.86% | 5.76% | 5.81% | 5.56% | 5.71% |
| processing oil | | | | | |
| (TDAE) | | | | | |
| Carbon black | 29.28% | 28.78% | 29.03% | 27.82% | 28.53% |
| Stearic acid | 0.59% | 0.58% | 0.58% | 0.56% | 0.57% |
| Zinc oxide | 1.76% | 1.73% | 1.74% | 1.67% | 1.71% |
| Accelerator | 0.59% | 0.58% | 0.58% | 0.56% | 0.57% |
| Sulfur | 1.02% | 1.01% | 1.02% | 0.97% | 1.00% |

TABLE 2

| | Compar- | | | | |
|---|---|---|---|---|---|
| | ative | Em- | Em- | Em- | Em- |
| | exam- | bodi- | bodi- | bodi- | bodi- |
| | ple 1 | ment 1 | ment 2 | ment 3 | ment 4 |
| Vulcanization | 3′05 | 3′29 | 3′38 | 3′28 | 3′30 |
| time (T 90 @ | | | | | |
| 175° C.) | | | | | |
| Tensile stress | 260.56 | 294.34 | 303.46 | 298.12 | 267.22 |
| (kg/cm²) | | | | | |
| M300 | 96.77 | 120.21 | 126.63 | 140.97 | 137.58 |
| (kg/cm²) | | | | | |
| Tanδ (60° C.; | 0.325 | 0.306 | 0.287 | 0.306 | 0.298 |
| strain 6%, 1 Hz) | | | | | |

The “vulcanization time (T 90 @ 175° C.)” of Table 2 is obtained based on the ASTM D2084 and ISO 3417 international standard specifications, and by analyzing a curve of relationship between degree of curing and vulcanization time of a sulphur-containing rubber composite material at a high temperature (150° C. to 195° C.) by a vulcameter. The present invention is set to analyze at 175° C. M300 (kg/cm²) represents a stress value at 300% tension, and the higher the stress value the harder it is. The lower the tan δ value the smaller the rolling resistance. It is able to be found from the results in Table 2 above: when the (Bis(triethoxysilylpropyl)tetrasulfide) is added, in both the tensile stress and the M300 items, all the embodiments show better performance than the comparative example 1 without the addition.

In the tan δ item, it is also observed that the tan δ values of the groups of the embodiments 1 to 4 in which the (Bis(triethoxysilylpropyl)tetrasulfide) is added are all lower than the tan δ value of the comparative example 1. It represents that when the formula of the present invention is employed in manufacturing a tire (for example, a tread rubber manufactured with this formula), the rolling resistance of the tire may be effectively reduced, the fuel consumption of the vehicle may be saved, and the effect of energy-saving may be achieved.

In summary, the present invention has the following features:

1. Products produced with the formula for manufacturing the elastic composite material of the present invention have been tested and have proved that the tensile strength is enhanced and the hardening time is also lengthened, which help to enhance the processability of the elastic composite material.

2. The present invention effectively reduces the loss factor tan δ by adding a specific ratio of the carbon material and the (Bis(triethoxysilylpropyl)tetrasulfide) in the silicon rubber material. Therefore, tires produced with the formula for manufacturing the elastic composite material of the present invention have relative low rolling resistance, may reduce oil consumption, and thereby have an energy-saving effect.

What is claimed is:

1. A manufacturing method for an elastic composite material, comprising:
mixing a carbon material with a silicon rubber material, and uniformly dispersing the carbon material in the silicon rubber material to form a mixed compound, wherein the carbon material is accounted for a weight percentage of between 0.01% and 20% of the mixed compound, the carbon material is selected from a group consisting of single-walled carbon nanotubes, multi-walled carbon nanotubes, graphene, graphene oxide, and combinations thereof, and the carbon material is treated with a functionalization to obtain a substituent group selected from carboxyl groups, hydroxyl groups, and combinations thereof;
mixing the mixed compound with a (Bis(triethoxysilylpropyl)tetrasulfide) and a cross-linking agent to form a mixture, wherein the cross-linking agent is accounted for a weight percentage of between 0.5% and 2% of the mixture; and
heating the mixture to harden it to obtain the elastic composite material.

2. The manufacturing method for the elastic composite material according to claim 1, further comprising a step of adding a filler in the mixture, wherein the filler is accounted for a weight percentage of between 10% to 65% of the total composition, and the filler is selected from a group consisting of carbon black, white smoke, carbon fiber, glass fiber, and combinations thereof.

3. A manufacturing method for an elastic composite material, comprising:
mixing a carbon material with a rubber processing oil, and uniformly dispersing the carbon material in the rubber processing oil to form a composite, wherein the carbon material is accounted for a weight percentage of between 0.005% and 10% of the composite, the carbon material is selected from a group consisting of single-walled carbon nanotubes, multi-walled carbon nanotubes, graphene, graphene oxide, and combinations thereof, and the carbon material is treated with a functionalization to obtain a substituent group selected from carboxyl groups, hydroxyl groups, and combinations thereof;
mixing the composite with a (Bis(triethoxysilylpropyl)tetrasulfide) and a cross-linking agent to form a mixture, wherein the cross-linking agent is accounted for a weight percentage of between 0.5% and 2% of the mixture; and
heating the mixture to harden it to obtain the elastic composite material.

4. The manufacturing method for the elastic composite material according to claim 3, the rubber processing oil being accounted for a weight percentage of between 0.00001% and 25% of the total composition.
